(19) United States
(12) Patent Application Publication
(10) Pub. No.: US 2004/0196659 A1
(43) Pub. Date: Oct. 7, 2004

(54) Orientation change device for lamp frame and light projection direction

(76) Inventor: Meiric Chen, Taipei Hsien (TW)

Correspondence Address: Meiric Chen, 235 Chung - Ho, Box 8-24, Taipei, TW

(21) Appl. No.: 10/403,413

(22) Filed: Apr. 1, 2003

(51) Int. Cl. F21S 8/06

(52) U.S. Cl. 362/405; 362/457

(57) ABSTRACT

An orientation change device serves for a lamp frame and light projection direction. An upper cap serves for guiding power. A lower end thereof is installed with an electric stud. Two ends of a connecting seat have insulated plugs. A conductive post is positioned in each of the plug at a position corresponding the electric stud. A plurality of lamp seat are fixed to a periphery of the connecting seat by a frame. An inner surface of the conductive post is conductive to a wire of one of a plurality of lamp seat. A plurality of wires are electrically connected to the conductive post. Then the plugs containing the conductive posts are installed at two ends of the connecting seat. Thereby, any one end of the connecting seat is connected to the upper cap. Thus, the conductive posts are connective to the electric stud.

### FIELD OF THE INVENTION

The present invention relates to lamp seats, and particularly to an orientation change device for a lamp frame and light projection direction. Thereby, the orientations of the lamp frame and light projection are adjustable to match the requirement of many applications.

### BACKGROUND OF THE INVENTION

In the prior art, a ceiling lamp has a lamp seat which is installed to a support frame. The support frame is connected to a connecting seat. Power is input to the lamp through the connecting seat. Therefore the appearance and the projection of light are fixed. Referring to FIG. 1, the lamp seat is suspended from the ceiling. After being connected to a power source, the bulb will light up. Light is projected upwards through the lampshade. Therefore, in above structure, the light projection is fixed and thus it is impossible to change the projection direction except that the whole lamp device is detached and replaced by a new one.

Moreover, if to update wires of the lamp is desired, it is necessary to detach the whole lamp device and a new lamp is attached. The work is tedious and complicated so that it is often executed by professional workman.

### SUMMARY OF THE INVENTION

Accordingly, the primary object of the present invention is to provide an orientation change device for a lamp frame and light projection direction. An upper cap serves for guiding power. A lower end thereof is installed with an electric stud. Two ends of a connecting seat have insulated plugs. A conductive post is positioned in each of the plug at a position corresponding the electric stud. A plurality of lamp seat are fixed to a periphery of the connecting seat by a frame. An inner surface of the conductive post is conductive to a wire of one of a plurality of lamp seat. A plurality of wires are electrically connected to the conductive post. Then the plugs containing the conductive posts are installed at two ends of the connecting seat. Thereby, any one end of the connecting seat is connected to the upper cap. Thus, the conductive posts are connective to the electric stud.

The various objects and advantages of the present invention will be more readily understood from the following detailed description when read in conjunction with the appended drawing.

### BRIEF DESCRIPTION OF THE DRAWINGS

FIG. 1 is a schematic view showing the installation of the prior art lamp.

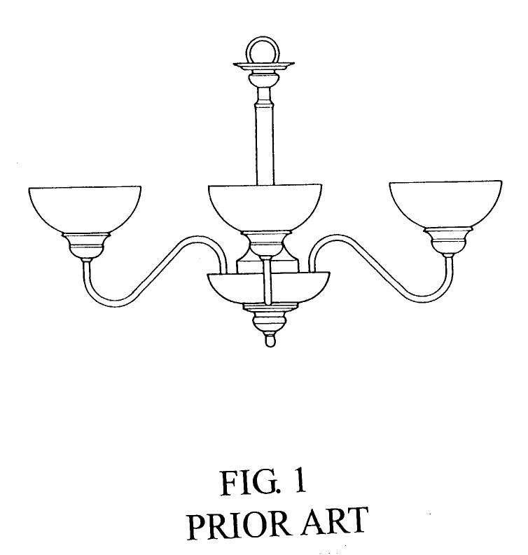

FIG. 2 is an exploded perspective view of the present invention.

FIG. 3 is an assembled perspective view of the present invention.

FIG. 4 is an assembled cross sectional view of the connecting seat of the present invention.

FIG. 5 is a schematic view showing the connection of the connecting seat and upper cap and the change of light projection according to the present invention.

FIG. 6 shows the application of the present invention, where another type of lamp seat is used according to the present invention.

FIG. 7 is a cross section view showing another end of a selected connecting seat being extended with an extended seat.

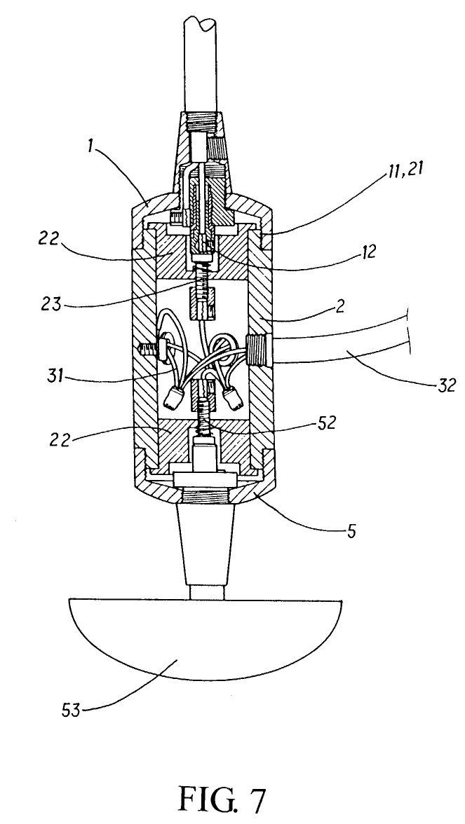

### DETAILED DESCRIPTION OF THE PREFERRED EMBODIMENTS

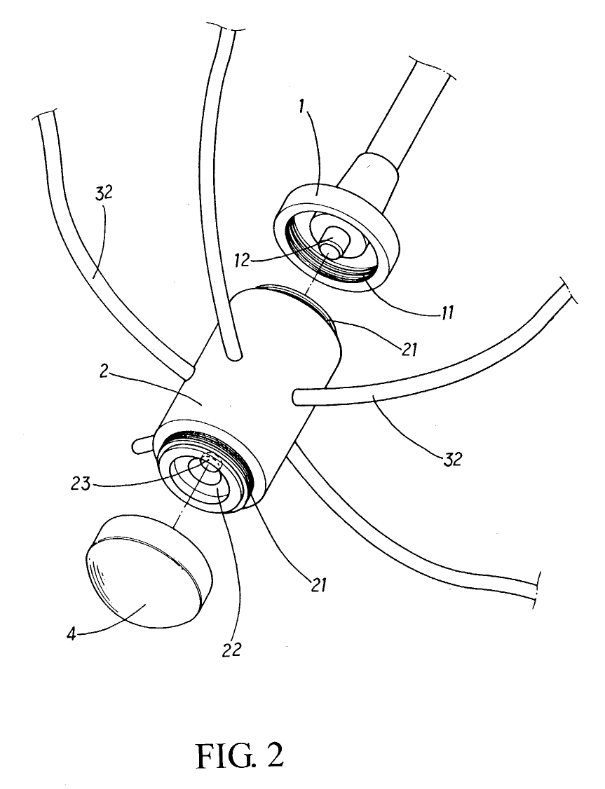

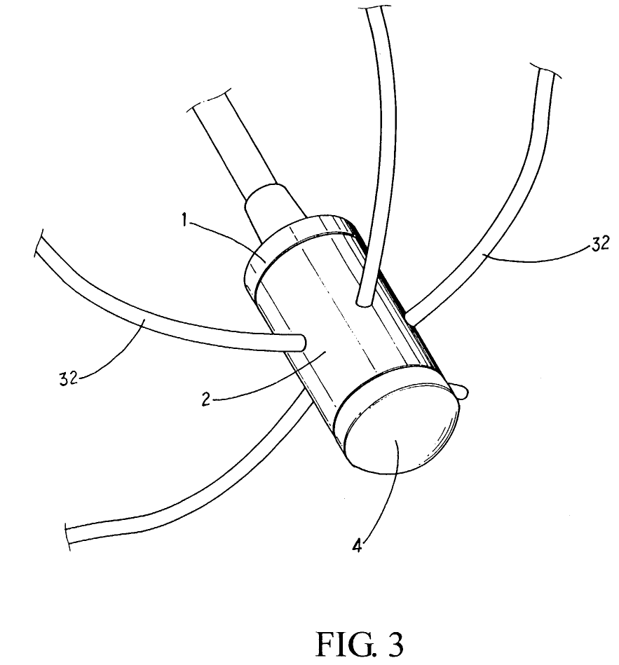

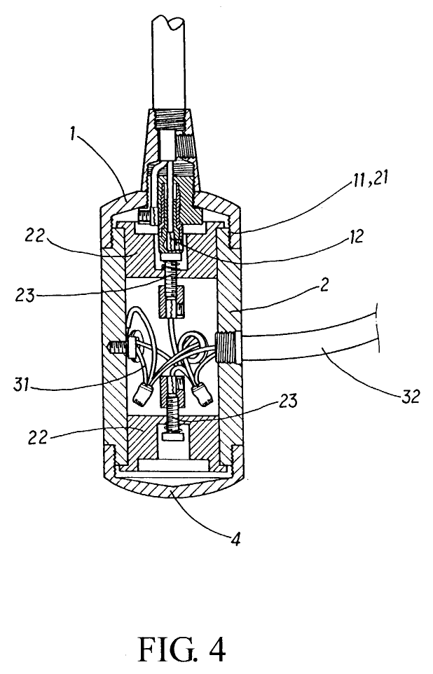

Referring to FIGS. 2 to 4, the orientation change device of a lamp frame and light projection direction of the present invention is illustrated. The orientation change device of a lamp frame and light projection direction comprises the following components.

An upper cap 1 serves for guiding power into the orientation change device. An interior of the upper cap 1 has female thread 11. A lower end thereof is installed with an electric stud 12.

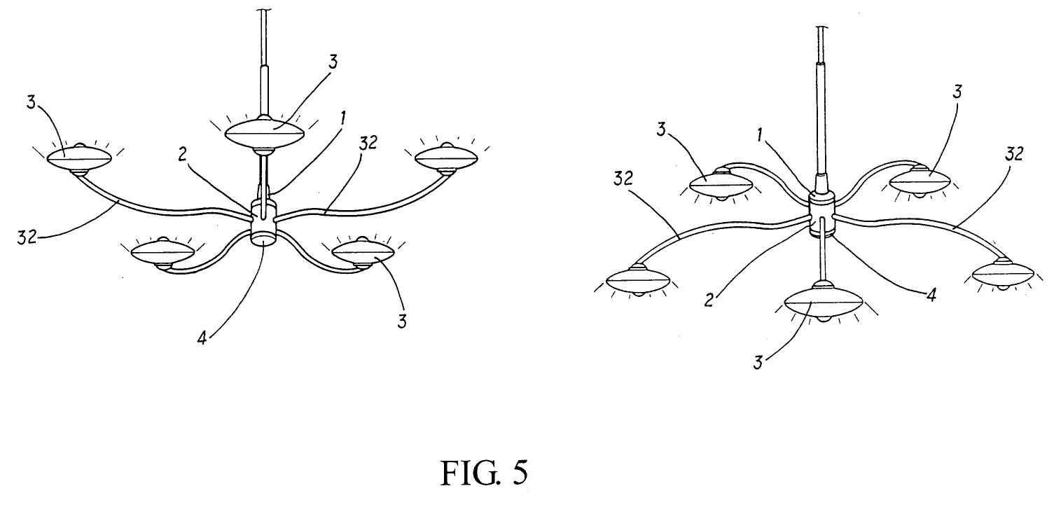

A connecting seat 2 is a cylinder and has a male thread 21 corresponding to the female thread 11 of the upper cap 1. Two ends of the connecting seat 2 have respective insulated plugs 22. A conductive post 23 is positioned in each of the plug 22 at a position corresponding the electric stud 12. An inner surface of the conductive post 23 is conductive to a wire 31 of one of a plurality of lamp seat 3. The plurality of lamp seat 3 is fixed to a periphery of the connecting seat 2 by the frame 32. A plurality of wires 31 are electrically connected to the conductive post 23. Then the plugs 22 containing the conductive posts 23 are installed at two ends of the connecting seat 2. Thereby, any one end of the connecting seat 2 is screwed to the upper cap I (referring to FIG. 5). Thereby, the conductive posts 23 are connective to the electric stud 12. Thus the object of the orientation change of a lamp frame and light projection direction is achieved.

Moreover, one end of the connecting seat 2 is firmly secured to the upper cap 1, and another end of the connecting seat 2 is installed with a cover 4. Then the shape of the cover 4 is changeable for preventing from being touched by others.

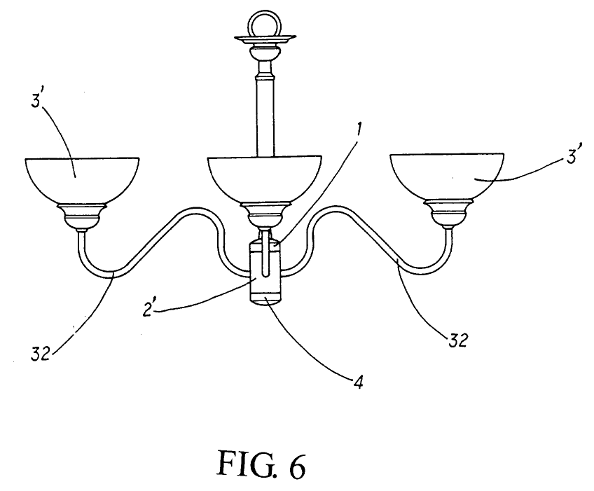

Referring to FIG. 6, the connecting seat 2 of the present invention can be modualized. Thereby, a plurality of connecting seats are assembled by assembling connecting seats of different sizes. In assembly, it is only necessary to take down the original lamp seat 3 and connecting seat 2. Then a corresponding lamp seat 3′ and connecting seat 2′ are connected thereto. The assembly work is easy and thus the working time is greatly reduced.

Referring to FIG. 8, one end of the connecting seat 2 is firmly secured and electrically connected to the upper cap 1. The conductive post 23 at another end is connected to the extending seat 5 of the electric stud 52. By the extending seat 5, another lamp 53 (for example, small night lamp) can be locked thereto. Thus, the connecting seat 2 is expandable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An orientation change device of a lamp frame and light projection direction comprising:
an upper cap for guiding power into the orientation change device; and a lower end thereof being installed with an electric stud;
a connecting seat being a cylindrical body; two ends of the connecting seat having respective insulated plugs; a conductive post being positioned in each of the plug at a position corresponding the electric stud;
a plurality of lamp seat being fixed to a periphery of the connecting seat by a frame; an inner surface of each conductive post being conductive to a wire of one of a plurality of lamp seat; a plurality of wires being electrically connected to the conductive posts; then the plugs containing the conductive posts being installed at two ends of the connecting seat; thereby, any one end of the connecting seat being connected to the upper cap; thus, the conductive posts being connective to the electric stud; and the object of the orientation change for a lamp frame and light projection is achieved.

2. The orientation change device of a lamp frame and light projection direction as claimed in claim 1, wherein any one end of the connecting seat being screwedly connected to the upper cap.

3. The orientation change device of a lamp frame and light projection direction as claimed in claim 1, wherein one end of the connecting seat is firmly secured to the upper cap, and another end of the connecting seat is installed with a cover.

4. The orientation change device for a lamp frame and light projection direction as claimed in claim 1, wherein one end of the connecting seat is firmly secured and electrically connected to the upper cap; the conductive post at another end is connected to the extending seat of the electric stud; by the extending seat, another lamp is locked thereto; thus, the connecting seat is expandable.
